(19) United States
(12) Patent Application Publication
(10) Pub. No.: US 2025/0331528 A1
(43) Pub. Date: Oct. 30, 2025

(54) PET TREAT HAVING REDUCED OR ELIMINATED ODOR

(71) Applicant: TDBBS, LLC, Richmond, VA (US)

(72) Inventors: Richard Louis SEELEY, Richmond, VA (US); Aaron David FAIRMAN, Richmond, VA (US); Patrick Lawrence GRAHAM, Midlothian, VA (US)

(21) Appl. No.: 19/186,869

(22) Filed: Apr. 23, 2025

Related U.S. Application Data
(60) Provisional application No. 63/638,096, filed on Apr. 24, 2024.

(51) Int. Cl. A23B 4/052; A23K 30/00; A23K 50/40

(52) U.S. Cl. CPC A23B 4/052; A23K 30/00; A23K 50/40

(57) ABSTRACT

A method of smoking and reducing or eliminating the odor of pet treats, comprising placing one or more pet treats within an internal cavity enclosed by a housing having one or more side walls, a rear wall, a top cover, a bottom floor, and a door; introducing smoke into the internal cavity using a cold smoker connected to one or more holes in at least one of said one or more side walls, wherein the smoke has a temperature below 86° F.; and removing the one or more pet treats from the internal cavity after being exposed to the smoke for a time period in the range of 3 hours to 8 hours. An apparatus for smoking and reducing or eliminating the odor of pet treats is also disclosed.

### FIELD

The present disclosure pertains to pet treats and more particularly to an apparatus and method for smoking and reducing or eliminating the odor of a pet treat, such as cold smoking of bully sticks.

### BACKGROUND

Pet treats such as bully sticks and many other pet food products have a natural odor that can be undesirable to pets and their owners. Past efforts at reducing or eliminating the odor have included drying and/or cooking the bully sticks to remove moisture.

Smoking bully sticks has also been performed in an effort to add a smoky taste and smell to the products. Nevertheless, smoking pet treats is time-consuming and it is difficult to efficiently and effectively smoke a high volume of treats.

### SUMMARY

An apparatus and method for removing or eliminating odor from pet treats sourced from animal by-products. The apparatus and method provide a smoke flavor to, e.g., bully sticks and other pet treats sourced from animals, via the use of a relatively more efficient cold smoking procedure that can be applied to a plurality of pet treats during the cold smoking procedure.

### BRIEF DESCRIPTION OF THE DRAWINGS

FIG. 1 is a perspective view of an embodiment of the apparatus for smoking pet treats without the doors, consistent with the present disclosure.

FIG. 2 is a perspective view of an embodiment of the apparatus for smoking pet treats having a plurality of racks within the internal cavity, consistent with the present disclosure.

FIG. 3 is a perspective view of an embodiment of the apparatus for smoking pet treats with the doors closed, consistent with the present disclosure.

FIG. 4A is a cross-sectional top view of an embodiment of the apparatus for smoking pet treats, consistent with the present disclosure.

FIG. 4B is a cross-sectional side view of an embodiment of the apparatus for smoking pet treats, consistent with the present disclosure.

FIG. 4C is a cross-sectional side view of an embodiment of the apparatus for smoking pet treats rotated 90 degrees from the cross-sectional view of FIG. 4B, consistent with the present disclosure.

FIG. 5 is a photograph showing a perspective of an embodiment of the apparatus for smoking pet treats, consistent with the present disclosure.

FIG. 6 is a photograph showing a second perspective of the embodiment of the apparatus for smoking pet treats shown in FIG. 5, consistent with the present disclosure.

FIG. 7 is a photograph showing the embodiment of the apparatus for smoking pet treats, shown in FIG. 5, with the doors open, revealing the internal cavity, consistent with the present disclosure.

FIG. 8 is a photograph showing the embodiment of the apparatus for smoking pet treats of FIG. 7 from a second perspective, consistent with the present disclosure.

FIG. 9A is a drawing of a front view of an embodiment of the apparatus for smoking pet treats, consistent with the present disclosure.

FIG. 9B is a drawing of a side view of an embodiment of the apparatus for smoking pet treats, consistent with the present disclosure.

FIG. 10 is a diagram of a method of smoking pet treats, consistent with the present disclosure.

### DETAILED DESCRIPTION

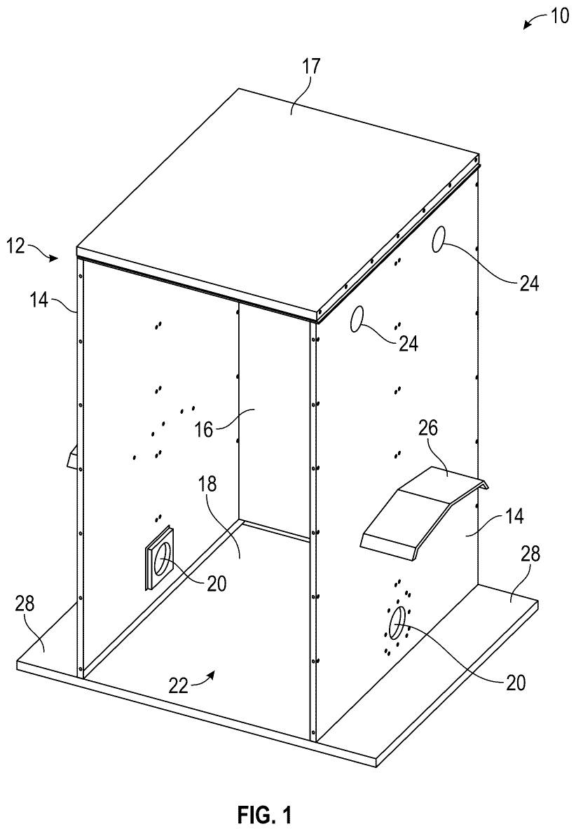

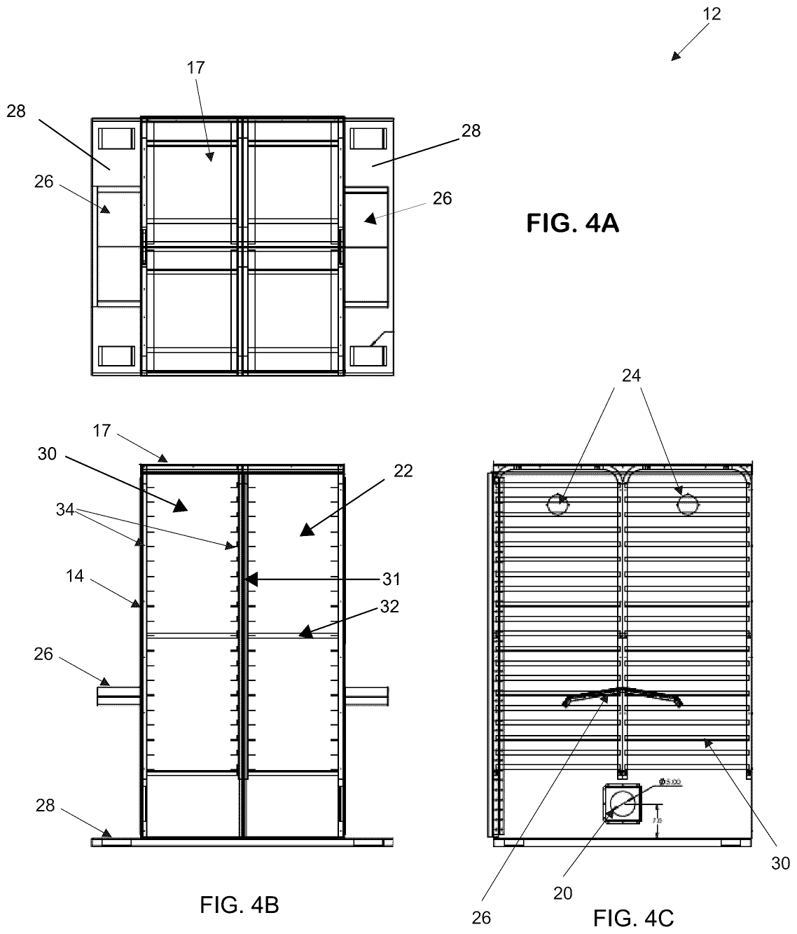

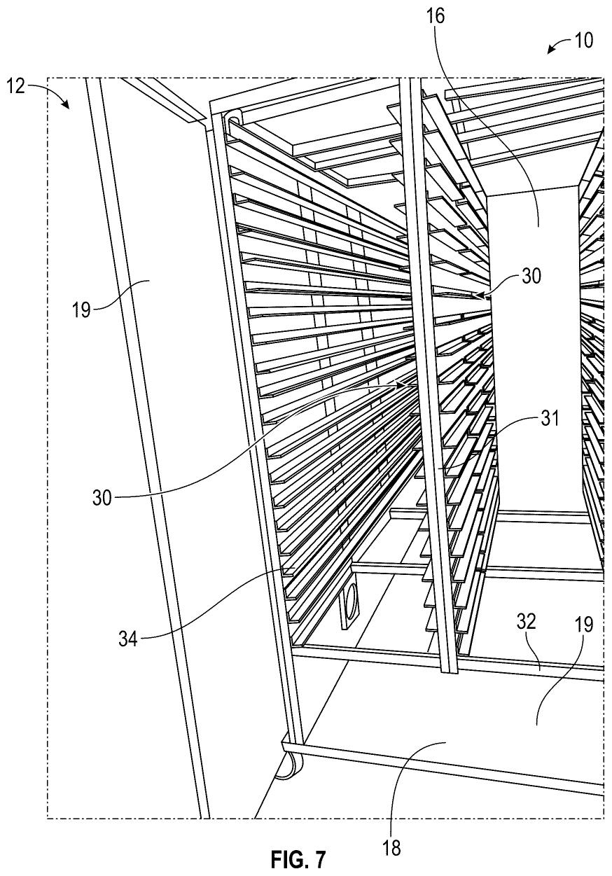

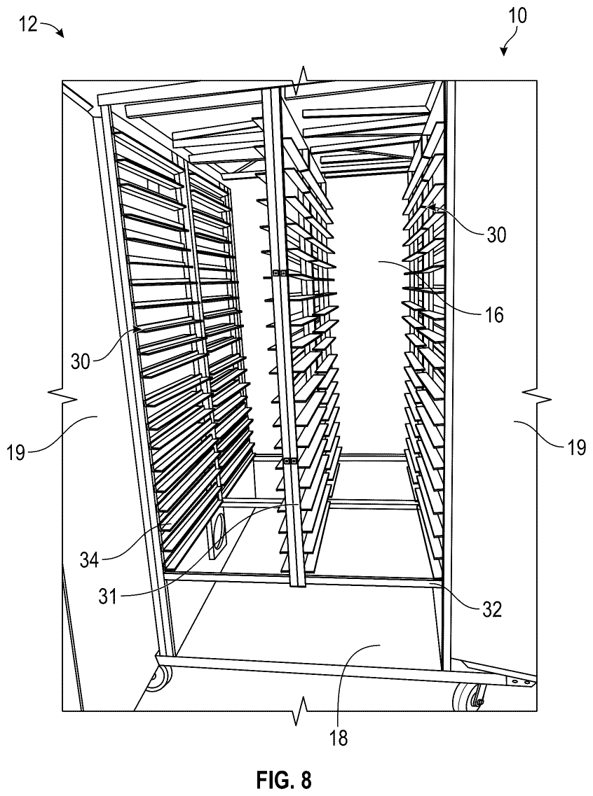

As shown in FIGS. 1 through 9, a preferred apparatus 10 is provided for smoking pet treats, such as bully sticks and other pet treats that are sourced from animal by-products. Bully sticks are reference herein to bull pizzle. Other pet treats that are contemplated herein include animal parts that otherwise provide a relatively foul-smelling odor to humans, particularly when dehydrated, if not subjected to the cold smoking procedures disclosed herein.

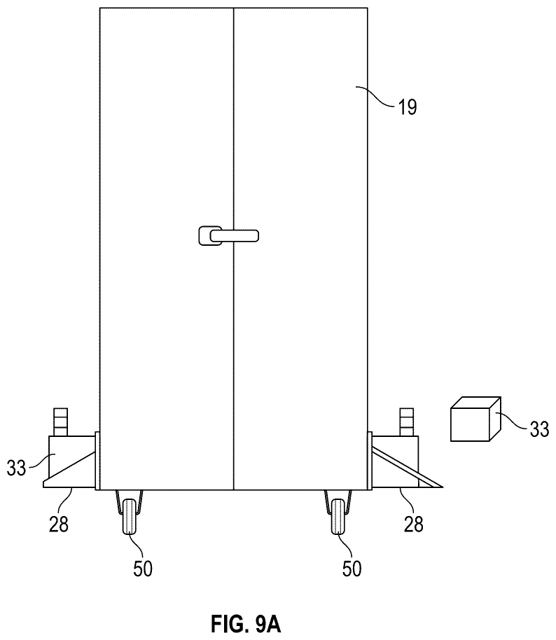

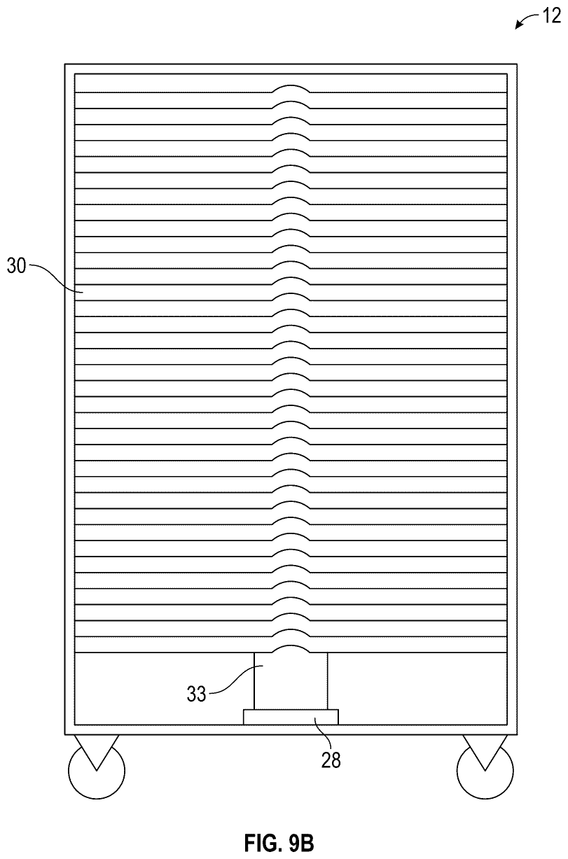

FIG. 1 depicts an embodiment of the apparatus 10 consistent with the present disclosure. As shown, the apparatus 10 preferably includes a housing 12 having side walls 14, a rear wall 16, a top cover 17, a bottom floor 18 and a door 19 (not shown in FIG. 1 to allow internal cavity 22 to be seen). The housing 12 may preferably enclose an internal cavity 22 and one or both side walls 14 may preferably be provided with one or more holes 20. The apparatus 10 may further include at least one smoker 33 (e.g., a cold smoker) as shown in FIGS. 9A and 9B. The one or more smokers 33 may be coupled to the one or more holes 20 such that smoke can be pumped from the smoker(s) 33 through the hole(s) into the internal cavity 22 of the housing 12.

Further shown in FIG. 1, the housing 12 may preferably be provided with one or more ventilation openings 24 on the side walls 14 and/or on one or more side walls 14 near the top. The ventilation openings 24 may preferably provide a conduit for smoke to exit the internal cavity. As can also be observed, the holes 20 are preferably placed on a lower portion of the housing 17. Accordingly, the holes 20 are preferably positioned such that they are within 24 inches or less of the surface of the bottom floor 18 of the apparatus 10, such as within 6.0 inches to 24.0 inches from the bottom floor 18, including all values and increments therein. Accordingly, the holes 20 may be positioned such that they are within 6.0 inches, 7.0 inches, 8.0 inches, 9.0 inches, 10.0 inches, 11.0 inches, 12.0 inches, 13.0 inches, 14.0 inches, 15.0 inches, 16.0 inches, 17.0 inches, 18.0 inches, 19.0 inches, 20.0 inches, 21.0 inches, 22.0 inches, 23.0 inches or 24.0 inches of the bottom floor 18. In turn, the ventilation openings 24 are also preferably positioned such that they are within 24 inches or less of the top cover 17, such as within 6.0 inches to 24.0 inches from the top cover, including all values and increments therein. Accordingly, the ventilation openings 24 may be positioned such that they are within 6.0 inches, 7.0 inches, 8.0 inches, 9.0 inches, 10.0 inches, 11.0 inches, 12.0 inches, 13.0 inches, 14.0 inches, 15.0 inches, 16.0 inches, 17.0 inches, 18.0 inches, 19.0 inches, 20.0 inches, 21.0 inches, 22.0 inches, 23.0 inches or 24.0 inches of the top cover 17.

The housing 12 is preferably formed and/or assembled using stainless steel. Stainless steel material contributes to easy cleaning, among other things.

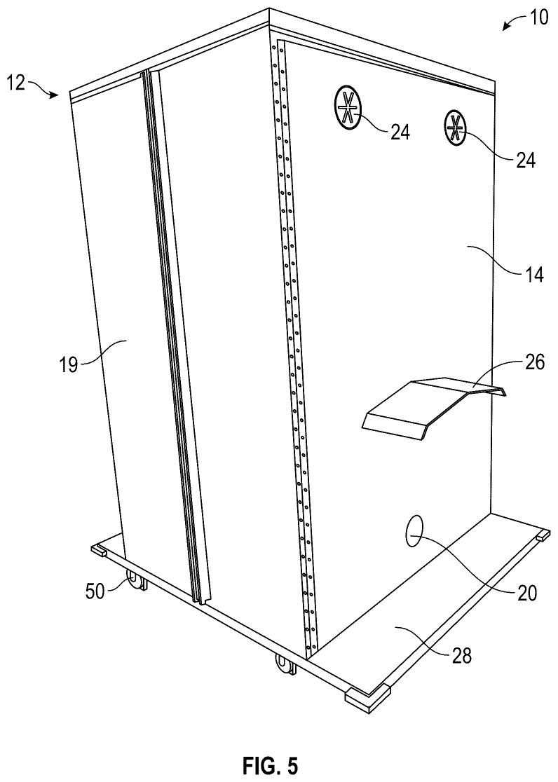

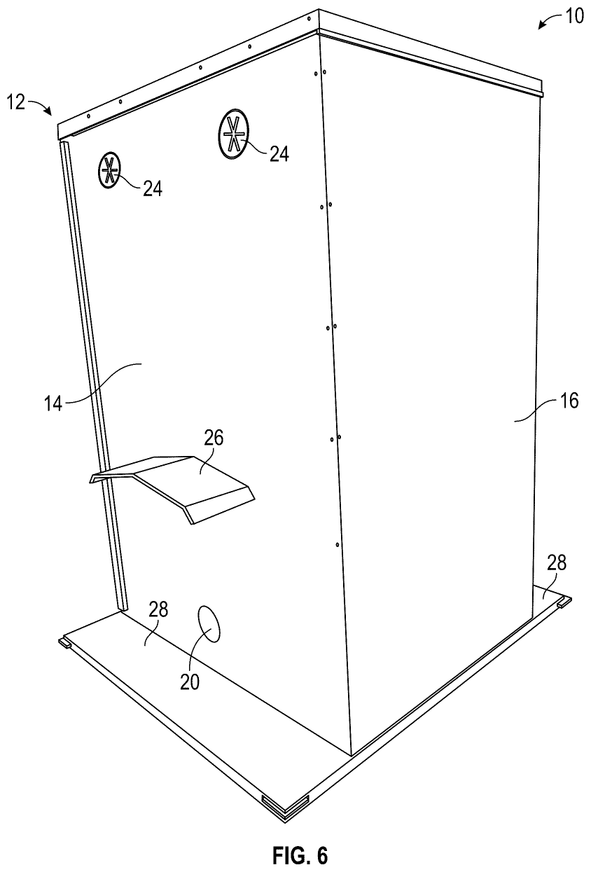

The apparatus 10 may preferably be mounted onto a plurality of casters or wheels 50 to, for example, facilitate portability. See FIG. 5. The plurality of casters or wheels 50 may preferably be mounted to a bottom surface of the housing.

The apparatus 10 may preferably include one or more precipitation covers 26 which may preferably be mounted the one or more side walls 14 of the housing 12 which include one of the one or more holes 20 such that the precipitation covers 26 are positioned above the one or more holes 20 and extend over at least a portion of a smoker 33 connected to said one or more hole 20. The precipitation covers 26 preferably deflect precipitation and/or other debris from falling into or onto the one or more holes 20 and/or onto the portion of the smoker 33 covered by the precipitation cover 26. As such, the precipitation covers 26 may preferably include one or more pitched segments where the pitched segments create a slopping surface that directs flow away from the one or more holes 20 and/or the portion of the smoker 33 covered by the precipitation cover 26.

The apparatus 10 may preferably additionally include one or more smoker supports 28 mounted or formed with the one or more side walls 14 that include a hole 20. A smoker support 28 may preferably provide a surface on which the smoker 33 may be supported when connected with the hole 20. As shown in FIG. 1, the smoker support 28 may, for example, be a portion of the bottom floor which extends beyond the one or more side walls 14.

As alluded to above, cold smoking is preferred, which is reference to a smoking procedure where the temperature is below the temperature where the meat proteins within the animal by-products denature (start to cook). Preferably, cold smoking is conducted at temperatures at or below 86° F. More preferably cold smoking herein may take place at temperatures in the range of 60° F. to 86° F., including all individual values and increments therein.

The quantity of holes 20 connected to cold smokers 33 is correlated to the time required to fill the internal volume with smoke. For example, by providing a plurality of holes 20 to introduce the cold smoke, such as 2 or more holes, the time it takes to cold smoke the pet treats, to reduce or eliminate an odor, is advantageously reduced compared to providing a single hole 20 to introduce cold smoke.

As noted above, cold smoking is preferably carried out at temperatures of at or below 86° F. Accordingly, the apparatus can function by applying cold smoke through the plurality of holes 20, thereby more efficiently cold smoking the pet treats maintained in the cavity 22. As may also be appreciated, by selectively positioning the holes 20 on opposing side walls 14, the flow of cold smoke that is introduced will impinge and provide a relatively increased concentration of cold smoke which then can be relied upon for the smoking of the pet treats. One may therefore also include a plurality of holes 20 to provide a plurality of impinging smoke streams.

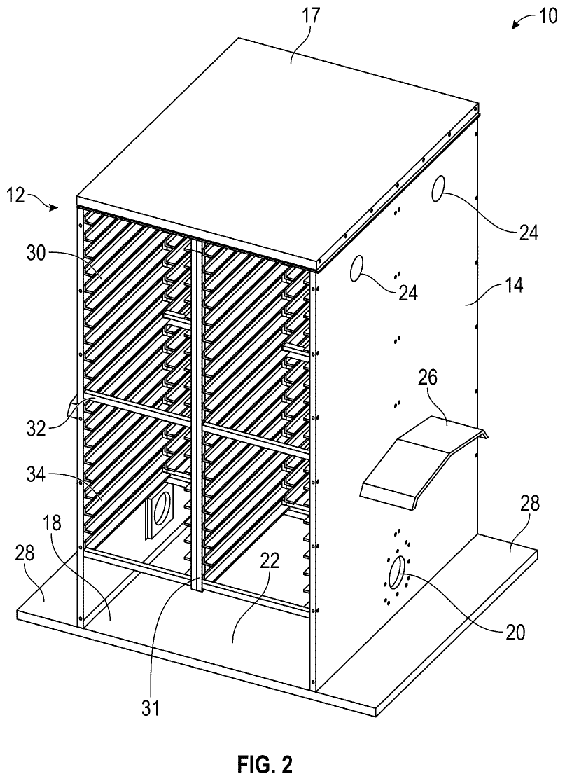

As depicted in FIG. 2, the internal cavity 22 is preferably provided with one or more racks 30. Individual trays (not shown) containing products to be smoked (i.e., pet treats) may be placed on the racks 30. The trays support the pet treats to be smoked. The internal cavity 22 may contain one or more racks 30.

The internal cavity 22 may preferably contain a plurality of racks 30 arranged within the internal cavity 22 in one or more columns and/or rows. The internal cavity 22 may contain one or more vertical supports 31 having a first end connected to the top cover 17 and/or a second end connected to the bottom floor 18. Further, internal cavity 22 may contain one or more horizonal supports 32 having a one or more ends connected to a side wall 14, the rear wall 16, and/or a vertical support 31. The one or more vertical supports 31 may provide a mounting or attachment location for the racks 30, for example where there is more than one column of racks 30 within the internal cavity 22. The one or more horizontal supports 32 may provide a mounting or attachment location for the racks 30 and/or provide structural support to the housing 12, vertical supports 31, and/or racks 30.

Each of the racks 30 may preferably be formed in or attached to one or more side walls 14, the rear wall 16, one or more vertical supports 31, and/or one or more horizontal supports 32. Each rack 30 may comprises one or more tray supports 34 where each tray support 34 is configured to support a tray containing pet treats or a portion thereof.

Alternatively, the racks 30 may comprise groove into which a portion of a tray containing pet treats may be slide such that the tray is maintained within the groove and supported within the rack 30.

In one embodiment, eighty or more rows across four or more columns of racks 30 can be supported within the cavity. It will be appreciated that the racks 30 can be used with any pet treat tray, and trays can be removed and replaced with one or more baskets depending upon the desired operation. The trays and baskets may comprise a solid surface and/or be comprised of a mesh surface. Further still, the trays and baskets may comprise a solid surface with a mesh grate placed or formed within the respective tray or basket, where the pet treats may be placed on the mesh grate above the solid surface of the tray or basket. Herein, a tray may be substantially flat while a basket may have a substantial depth. The overall dimensions of the device are suitable to be retained in areas with limited space, including small warehouses.

In various embodiments, the housing has multiple levels, such as up to 30-35 rows, each of which include a plurality of columns which can each fit a tray, more preferably up to four columns each fitting a tray. An exemplary tray size is twenty-eight inches by sixteen inches and an exemplary height between rows is approximately 1.0 inches to 2.0 inches.

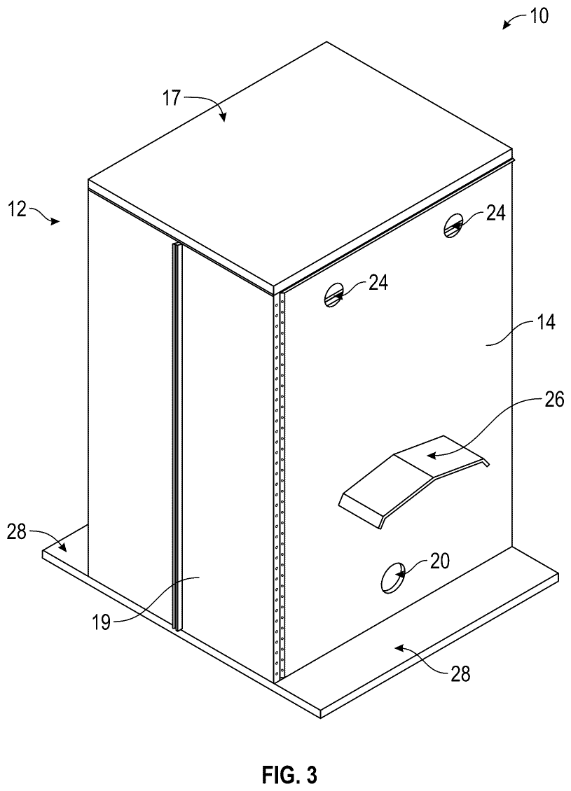

FIG. 3 depicts an embodiment of the housing 12 including the doors 19. As shown by the embodiment of the doors in FIG. 3, the doors 19 may preferably be mated to one or more side walls 14, the top cover 17, and/or bottom floor 18. More specifically, the doors 19 may preferably be hingedly mated to one or more side walls 14, the top cover 17, and/or bottom floor 18. The doors 19 may preferably have one or more panels. Though the embodiment depicted in FIG. 3 includes two panels hingedly mated to opposing side walls 14, this should not be seen as limiting the quantity, orientation, or mating mechanism which may be used to make up the doors 19 of the present disclosure.

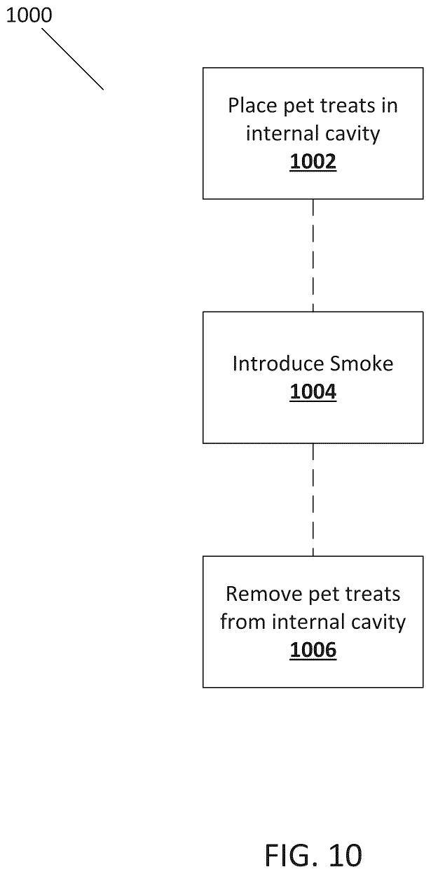

A n embodiment of a method of smoking pet treats is represented by the diagram shown in FIG. 10. In step 1002, pet treats such as animal parts that need smoking for removal or reduction of odor may preferably be placed within the internal cavity 22 of the housing 12 of the apparatus 10. Where the apparatus 10 includes racks 33, the pet treats may preferably be placed on the one or more trays (or baskets) and the trays (or baskets) may be placed on the one or more racks, as described above. In step 1004, the cold smokers 33 may preferably pump cold smoke into the cavity 22 to smoke and preferably remove or reduce odor from the edible pet treats such as bully sticks. In various embodiments, the process of smoking and reducing or removing odor preferably can take less than or equal to 8.0 hours. More preferably, the pet treats may be smoked for a time in the range of 3-8 hours, including all individual values and increments therein. One particularly preferred time-period for cold smoking is 3-5 hours. Once completed, in step 1006, the pet treats are removed from the cavity 22 and then preferably stored or placed directly in bags.

Different smoke flavors (mesquite, hickory, etc.) can be employed to give the finished product a distinct and relatively more appealing smell. The presently disclosed apparatus and method thus can effectively reduce or remove odor from animal parts such as bully sticks, providing a relatively distinct smoke flavor which remains attractive and appealing to pets and their owners. The bully sticks that may be employed herein for cold smoking are those that preferably have a length of 12.0 inches or less, more preferably in the range of 6.0 inches to 12.0 inches, including all individual values and increments therein.

The foregoing description details certain embodiments of the present disclosure. It will be appreciated, however, that no matter how detailed the foregoing appears in text, embodiments of the apparatus disclosed herein can be practiced in many ways. The use of particular terminology when describing certain features or aspects of the present disclosure should not be taken to imply that the terminology is being re-defined herein to be restricted to including any specific characteristics of the features or aspects of the disclosure with which that terminology is associated.

It will be appreciated that the apparatus and method described herein are not limited to the particular embodiments illustrated in the drawings and described above in detail. Those skilled in the art will recognize that other arrangements could be devised. The present disclosure encompasses every possible combination of the various features of each embodiment disclosed.

One or more of the elements described herein with respect to various embodiments can be implemented in a more separated or integrated manner than explicitly described, or even removed or rendered as inoperable in certain cases, as is useful in accordance with a particular application. While reference to specific illustrative embodiments is made herein, modifications and variations of the present disclosure may be constructed without departing from the spirit and scope of the embodiments as set forth herein.

What is claimed is:

1. An apparatus for smoking and reducing or eliminating the odor of pet treats, comprising:
a housing having one or more side walls, a rear wall, a top cover, a bottom floor, and a door, the housing enclosing an internal cavity;
one or more holes in at least one of said one or more side walls; and
one or more cold smokers configured to pump cold smoke into the internal cavity via at least one of the one or more holes, wherein the cold smoke has a temperature below 86° F.

2. The apparatus of claim 1, wherein the temperature of the smoke is in the range of 60° F. to 86° F.

3. The apparatus of claim 1, wherein the smoke includes a smoke flavor.

4. The apparatus of claim 3, wherein the smoke flavor is mesquite or hickory.

5. The apparatus of claim 1, wherein the internal cavity includes one or more racks configured to hold one or more trays containing the one or more pet treats.

6. The apparatus of claim 5, wherein the internal cavity includes one or more columns and one or more rows of racks.

7. The apparatus of claim 1, wherein the housing further includes one or more ventilation holes.

8. The apparatus of claim 1, further comprising a precipitation cover mounted on an outside surface of the one or more side walls of the housing, the precipitation covers being arranged above the one or more holes and at least a portion of the cold smoker.

9. The apparatus of claim 1, further comprising a plurality of wheels mounted on a bottom surface of the housing.

10. The apparatus of claim 1, wherein the housing comprises stainless steel.

11. A method of smoking and reducing or eliminating the odor of pet treats, comprising:
placing one or more pet treats within an internal cavity enclosed by a housing having one or more side walls, a rear wall, a top cover, a bottom floor, and a door;
introducing smoke into the internal cavity using a cold smoker connected to one or more holes in at least one of said one or more side walls, wherein the smoke has a temperature below 86° F.; and
removing the one or more pet treats from the internal cavity after being exposed to the smoke for a time period in the range of 3 hours to 8 hours.

12. The method of claim 11, wherein the temperature of the smoke is in the range of 60° F. to 86° F.

13. The method of claim 11, wherein the one or more pet treats are removed from the internal cavity after being exposed to the smoke for a time period in the range of 3 hours to 5 hours.

14. The method of claim 11, further comprising, placing the one or more pet treats on one or more trays and placing the one or more trays within the internal cavity.

15. The method of claim 14, further comprising placing the one or more trays on one or more racks within the internal cavity.

16. The method of claim 11, wherein the smoke has a smoke flavor.

17. The method of claim 16, wherein the smoke flavor is one of mesquite or hickory.

18. The method of claim 11, wherein the housing further includes one or more ventilation holes.

19. The method of claim 11, wherein a precipitation cover is mounted on an outside surface of the one or more side walls of the housing, the precipitation covers being arranged above the one or more holes and at least a portion of the cold smoker.

20. The method of claim 11, wherein the housing further includes ventilation holes for the smoke to exit the internal cavity.
